(19) United States
(12) Patent Application Publication
(10) Pub. No.: US 2024/0169267 A1
(43) Pub. Date: May 23, 2024

(54) COMPOSITE TRAINING TECHNIQUES FOR MACHINE LEARNING MODELS

(71) Applicant: Optum, Inc., Minnetonka, MN (US)

(72) Inventors: Nadav Rakocz, Los Angeles, CA (US); Dominik Roman Christian Dahlem, Dublin (IE); Eran Halperin, Santa Monica, CA (US)

(21) Appl. No.: 18/492,189

(22) Filed: Oct. 23, 2023

Related U.S. Application Data
(60) Provisional application No. 63/529,219, filed on Jul. 27, 2023.
(60) Provisional application No. 63/384,941, filed on Nov. 23, 2022.

(51) Int. Cl. G06N 20/00

(52) U.S. Cl. CPC G06N 20/00

(57) ABSTRACT

Various embodiments of the present disclosure provide machine learning training techniques for training a model to improve upon traditional prediction models for various prediction domains. The techniques may include receiving training tuples for a training entity. A machine learning model may be used to generate a prediction output for the training entity based on the training tuples. A composite loss function may be used to generate a composite loss metric for the machine learning model that is based on (i) a first loss metric based on a comparison between the prediction output and a plurality of historical reward measures and (ii) a second loss metric based on a comparison between the prediction output and an imitation output corresponding to the prediction output. One or more model parameters of the first machine earning model may be modified based on the composite loss metric.

### CROSS REFERENCE TO RELATED APPLICATION

This application claims the priority of U.S. Provisional Application No. 63/529,219, entitled “SCALABLE CLINICAL DECISION SUPPORT SYSTEMS USING TRANSFORMER ARCHITECTURES,” filed on Jul. 27, 2023 and U.S. Provisional Application No. 63/384,941, entitled “SCALABLE CLINICAL DECISION SUPPORT SYSTEMS USING TRANSFORMER ARCHITECTURES,” filed on Nov. 23, 2022, both of which are hereby incorporated by reference in their entireties.

### BACKGROUND

Various embodiments of the present disclosure address technical challenges related to machine learning models and predictive modelling techniques that leverage machine learning models, such as intelligent recommendation engines. Intelligent recommendation engines may be used across multiple prediction domains to generate predictive recommendations. For example, in a clinical domain, clinical care routinely involves planning treatments for patients carefully considering potential risks and benefits of the available treatment options. Clinical practice guidelines (CPGs) published by medical associations are based on the best available population-level evidence and are intended to assist healthcare professionals in making clinical decisions. However, this also implies that the CPGs are not designed to the clinical needs of specific patients. Further, dealing with potentially polychronic patients poses technical challenges that may lead to adverse interactions. Thus, while CPGs are helpful as general guidelines, recommendations are traditional made that deviate from applicable guidelines partially or fully to tailor treatments to a particular individual.

Traditionally, machine learning models are leveraged to generate recommendations that allow for deviations from policies within a prediction domain. However, traditional approaches have several limitations including a reliance on up-to-date, continuous, and accurate information. Moreover, traditional techniques are trained to either mirror traditional policies or maximize loss functions that do not account for traditional polices. Such techniques are either constrained to a portion of a potential prediction domain or are too flexible and lead to unconventional recommendations that are not grounded by traditional knowledge bases. Thus, neither approach suitable for many prediction domains, including common clinical scenarios, such as the management of chronic disease for polychronic patients, where the data per patient is only observed irregularly and the number of combinations of treatment and other clinical actions is large and must be grounded at least partially by traditional policies.

Various embodiments of the present disclosure make important contributions to traditional machine learning techniques by addressing each of these technical challenges.

### BRIEF SUMMARY

Various embodiments of the present disclosure provide training techniques to improve traditional machine learning models through learning functions designed to balance potential rewards against manual policies for a prediction domain. Using some of the techniques of the present disclosure, a machine learning model may be trained to utilize the sequential nature of decision-making trajectories to treat a reinforcement learning problem as a conditional sequence modeling problem and leverage a transformer's ability to effectively capture long-range dependencies while also synthesizing disparate well-performing actions across many medical histories. To establish a trustworthy grounding for the machine learning model, the model may be trained using a composite loss function that balances the predictions of the model between two performance metrics, an expected outcome loss and an imitation loss. The first performance metric, expected outcome loss, optimizes a potential reward for a recommendation, whereas the imitation loss optimizes a matching between a prediction and a manual policy. By intelligently accounting for each to two dueling performance requirements, the composite loss function may be leveraged to improve machine learning model predictions while grounding them in traditional, well established, policies. In this manner, the composite loss function may enhance the reliability, accuracy, and potential rewards achievable by machine learning models in any prediction domain.

In some embodiments, a computer-implemented includes receiving, by one or more processors, a plurality of training tuples for a training entity; generating, by the one or more processors and using a first machine learning model, a prediction output for the training entity; generating, by the one or more processors and using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and modifying, by the one or more processors, one or more model parameters of the first machine learning model based on the composite loss metric.

In some embodiments, a computing system includes memory and one or more processors communicatively coupled to the memory, the one or more processors are configured to receive a plurality of training tuples for a training entity; generate, using a first machine learning model, a prediction output for the training entity; generate, using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and modify one or more model parameters of the first machine learning model based on the composite loss metric.

In some embodiments, one or more non-transitory computer-readable storage media includes instructions that, when executed by one or more processors, cause the one or more processors to receive a plurality of training tuples for a training entity; generate, using a first machine learning model, a prediction output for the training entity; generate, using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and modify one or more model parameters of the first machine learning model based on the composite loss metric.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with one or more embodiments of the present disclosure.

FIG. 3 is a dataflow diagram showing example data structures and modules for performing predictive operations on an input temporal sequence in accordance with some embodiments discussed herein.

FIG. 4 is a flowchart diagram of an example process for performing predictive operations on an input temporal sequence in accordance with some embodiments of the present disclosure.

FIG. 5 is a dataflow diagram showing example data structures and modules for a composite training technique in accordance with some embodiments discussed herein.

FIG. 6 is a flowchart diagram of an example process for training a machine learning model in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout. Moreover, while certain embodiments of the present disclosure are described with reference to predictive data analysis, one of ordinary skills in the art will recognize that the disclosed concepts may be used to perform other types of data analysis.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial. NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

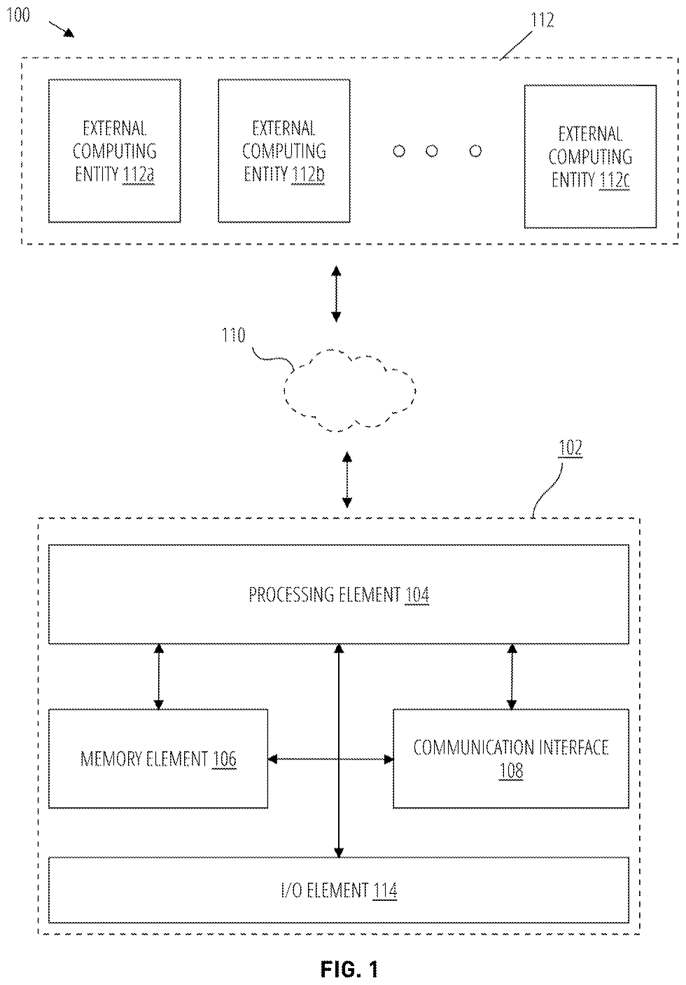

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., training techniques, prediction techniques, and/or the like) described herein.

The external computing entities 112a-c, for example, may include and/or be associated with one or more entities that may be configured to receive, store, manage, and/or facilitate datasets that include temporal sequences, and/or the like. The external computing entities 112a-c may provide the input data, such as temporal sequences, tuples, and/or the like to the predictive computing entity 102 which may leverage the input data to generate prediction outputs and/or the like. By way of example, the predictive computing entity 102 may include a causal transformer model that is configured to leverage temporal sequences to generate predictive insights for a user. In some examples, the input data may include an aggregation of data from across the external computing entities 112a-c into one or more temporal sequence with a plurality tokens. The external computing entities 112a-c, for example, may be associated with one or more data repositories, cloud platforms, compute nodes, organizations, and/or the like, that may be individually and/or collectively leveraged by the predictive computing entity 102 to obtain and aggregate data for a prediction domain.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

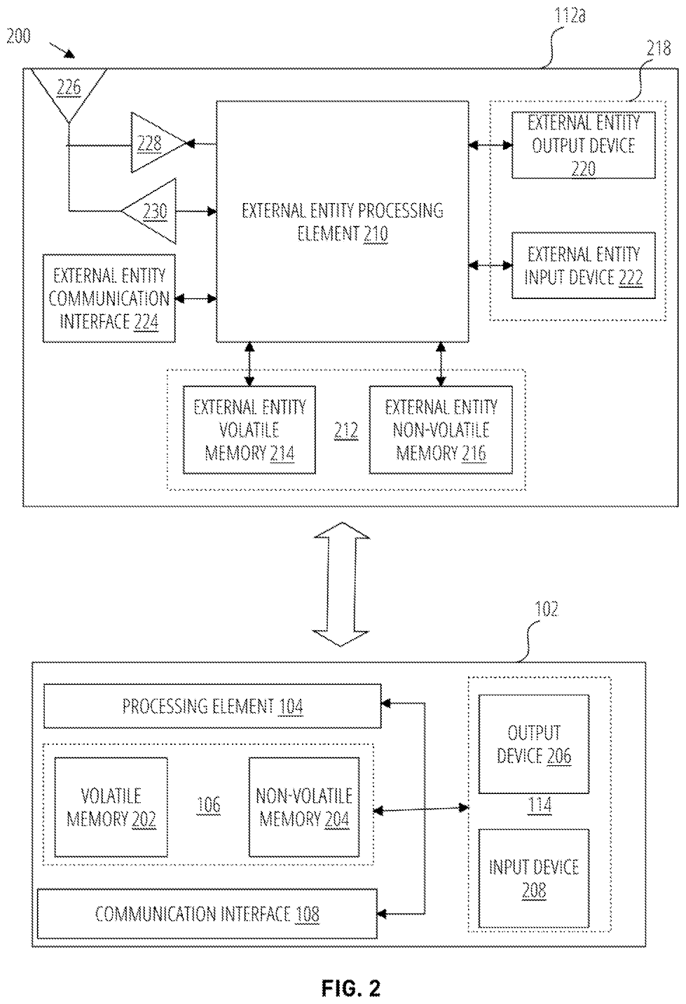

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing clement 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more steps/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product includes non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing clement 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “temporal sequence” refers to a temporal sequence that corresponds to a respective entity. A temporal sequence, for example, may describe a time series of one or more tuples associated with instances of encounters with an entity. For example, a temporal sequence may include a sequence of one or more tuples. In some embodiments, a temporal sequence may be provided to as a prediction input to a decision support machine learning model framework that includes a causal transformer model to generate a prediction output based on the temporal sequence. A temporal sequence may include data from images, text files, audio/video files, application files, and/or the like. In some examples, an entity may include a computing device and/or a temporal sequence may be generated from a system log including a time series of a plurality of tuple data objects associated with a computing device's history of encounters (e.g., incidents, interactions, data access/modifications, infiltrations, data exfiltration, etc.). In some examples, the entity may depend on the prediction domain. For example, in a clinical domain, an entity may include a medical patient and a temporal sequence may be derived, generated, and/or the like from electronic health records (EHRs) for the entity that include a time series of a plurality of tuple data objects associated with a patient's history of encounters (e.g., visits, admissions, meetings, etc.).

In some embodiments, a temporal sequence is representative of an entity's trajectory with respect to a measured aspect of a prediction domain. For example, in a clinical domain, a temporal sequence may represent an entity's health trajectory with respect to a particular condition, treatment, outcome, and/or the like over multiple clinical encounters. In some examples, each tuple of the temporal sequence may represent an encounter of an entity's trajectory such that a temporal sequence may be represented as:

τ={c,{sₜ, aₜ, rₜ}ₜ₌₀^{T}}

where an encounter at time t (e.g., aggregated encounters over a month) may be converted into the tuple (sₜ, aₜ, sₜ) which, in a clinical domain, records an entity's physiological state (sₜ∈S), an action token representing one or more actions that were taken during the encounter (aₜ∈A), and an outcome (rₜ∈R). In some examples, an additional token c∈C is added to represent static information for an entity, such as a patient's age, sex, demographics, and/or the like in a clinical domain. In some examples, the temporal sequence may include a plurality of sequential tuples for an entity that includes a respective tuple for one or more time segments within an evaluation time period T. Each time segment, for example, may include a month of an evaluation time period. In some examples, the evaluation time period may include a two year time period such that the temporal sequence may include a maximum of twenty-four tuples for the entity.

In some embodiments, the term “input temporal sequence” refers to a temporal sequence that is input to a machine learning model to generate a prediction output for an entity. An input temporal sequence may be leveraged for one or more inference operations of the present disclosure.

In some embodiments, the term “training temporal sequence” refers to a temporal sequence that is input to a machine learning model to generate a prediction output for a training entity. A training temporal sequence may be leveraged for one or more training operations of the present disclosure.

In some embodiments, the term “tuple” refers to a data construct that describes an element of a temporal sequence. For example, a tuple may include a plurality of tuple data objects that include data representative of one or more states, combinations of actions, outcomes, cumulative discounted future outcomes, and/or the like for an entity. In some examples, the plurality of tuple data objects may include one or more tokens, such as a state token, sₜ, an action token, aₜ, outcome token, rₜ, and/or the like. For example, an encounter instance may be represented by a tuple that includes a plurality of tuple data objects in the form (sₜ, aₜ, rₜ). Relative to a timestamp (t), a state token, s, may be indicative of a state for an entity (e.g., a computing device state, a diagnostic code, a physical/physiological state, etc.), an action token, a, may be indicative of one or more actions and/or action combinations for the entity, and a outcome token, r, may be indicative of one or more outcomes (e.g., increase in computing device performance, an improvement in condition, a reduction in disease severity, inpatient stay occurring, etc.) after the one or more actions a are taken. In some examples, a plurality of tuple data objects may include a cumulative discounted future outcome, Rₜ, such that the tuple has the form of (sₜ, aₜ, tₜ, Rₜ). A cumulative discounted future outcome may include a sum of all discounted future outcomes in a temporal sequence associated with a tuple. In some embodiments, the cumulative discounted future outcome may be determined with a discount factor γ, e.g., Rₜ=Σ_{t′=t}^{T}γ^{t′}r_{r′}. In another embodiment, the cumulative discounted future outcome may be windowed with a horizon parameter w, e.g., Rₜ=Σ_{t′=t}^{t+w}r_{t′}.

In some examples, the tuple may correspond to a time segment of an evaluation time period defined by the temporal sequence. In some examples, a tuple may define data that is representative of one or more encounter instances within a time segment of an evaluation time period. By way of example, one or more encounter instances that occur within a single time segment (e.g., a week, month, etc.) may be aggregated into a singular encounter. In terms of actions, this implies that all distinct actions that occurred within the same time segment may be included as part of the same encounter. For outcomes, a highest recorded outcome (e.g., severity level, etc.) within the time segment may be used as the outcome for the encounter. In this manner, actions and outcomes may be consolidated to provide a concise representation of the data, allowing for statistical signal processing through machine learning while retaining temporal information.

In some embodiments, the term “input tuple” refers to a tuple of an input temporal sequence.

In some embodiments, the term “training tuple” refers to a tuple of a training temporal sequence. In some examples, a training tuple may describe a training encounter instance within a training temporal sequence. A training tuple may include a plurality of training tuple data objects including data representative of training states, training combinations of actions, training outcomes, and/or a training cumulative discounted future outcome. In some examples, the one or more training outcomes may be associated with a given one of the one or more training states proceeding a respective one of the one or more training combinations of actions. In some examples, the training cumulative discounted future outcome may be associated with a given one of the one or more training tuples within the at least one of plurality of training temporal sequences.

In some embodiments, the term “tuple data object” refers to a data construct that describes an attribute of a tuple associated with an encounter instance within a temporal sequence. A tuple data object may describe an attribute of a tuple associated with an encounter instance within a temporal sequence. For example, a tuple of a temporal sequence may include a plurality of tuple data objects including data representative of (i) one or more states, (ii) one or more actions and/or combinations thereof, and/or (iii) one or more outcomes associated with a given one of the one or more states proceeding a respective one of the one or more actions. In some examples, a tuple data object may include data representative of a cumulative discounted future outcome. A plurality of tuple data objects within a temporal sequence may be internally related and/or include correlations of various degrees that may be interpreted with various meanings. For example, a tuple may represent a computing device incident on a given date and include a plurality of tuple data objects including data representative of one or more computing device status (state), one or more combination of actions, one or more computing device outcomes, and/or a cumulative discounted future computing device outcome associated with the computing device incident. As another example, a tuple may represent a patient admission on a given date and include a plurality of tuple data objects including data representative of one or more patient conditions (state), one or more combination of treatments (combination of actions), one or more clinical outcomes, and/or a cumulative discounted future clinical outcome associated with the patient admission.

In some embodiments, the term “input tuple data object” refers to an attribute of a tuple of an input temporal sequence.

In some embodiments, the term “training tuple data object” may refer to a data construct that describes an attribute of a tuple associated with a training encounter instance within a training temporal sequence. For example, a training tuple of a training temporal sequence may include a plurality of training tuple data objects including data representative of (i) one or more training states, (ii) one or more training combinations of actions, (iii) one or more training outcomes associated with a given one of the one or more training states proceeding a respective one of the one or more training combinations of actions, and/or (iv) a training cumulative discounted future outcome associated with the training tuple within the training temporal sequence.

In some embodiments, the term “token” refers to a data construct that describes a unique representation of a tuple data object in a format suitable for processing by a machine learning model. For example, a token may include one or more integers and/or characters representative of features of a tuple data object. A token may be formatted according to integer values, binary values, or hexadecimal values. A tuple data object may be converted into a token using a predefined mapping of features associated with the tuple data object to the token. In some embodiments, a token may be generated for a tuple data object based on its tuple data object type (e.g., state, combination of actions, outcome, and/or cumulative discounted future outcome) represented by the tuple data object. For example, an action token may be assigned to each specific combination of actions (e.g., individual, pairwise, or higher order) in a tuple including one or more tuple data objects including data representative of one or more combinations of actions. In some examples, a state token may be assigned to each state in a tuple including one or more tuple data objects including data representative of one or more states (e.g., a unique physiological state, etc.). In some examples, a token may be assigned to each outcome or discounted future outcome in a tuple including one or more tuple data objects including data representative of one or more outcomes and/or discounted future outcomes. In some examples, tokenizing discounted future outcomes may include sampling the discounted future outcomes into discrete values by dividing the discount outcomes into M quantiles and mapping each quantile into a single token.

In some embodiments, the term “conditional distribution of actions” refers to a data construct that describes a distribution of probability values associated with occurrence of a plurality of actions. In some embodiments, the conditional distribution may be generated by determining, for one or more states associated with a tuple of a temporal sequence, a number of action combination tokens that are present within the tuple associated with tuple data objects including data representative of a specific state. In some embodiments, one or more of the plurality of action combination tokens may be excluded from the conditional distribution of actions based on the excluded one or more action combination tokens including probability scores below a threshold. In some embodiments, the excluded one or more of the plurality of action combination tokens may be replaced with one or more action combination tokens including most frequent actions or actions coincident with the largest number of action combination tokens that are present within the tuple that are similar to the excluded one or more of the plurality of action combination tokens.

In some embodiments, the term “action space data object” refers to a data construct that describes a list of individual actions including possible actions that may exist in combinations of actions associated with training temporal sequences and/or used to generate a prediction output by a causal transformer machine learning model. For example, an action space data object may be generated based on expert knowledge data, guidelines data, or databases associated with a given subject matter or including actions that may be present in temporal sequences. In some embodiments, an action space data object may be used to assign a plurality of action combination tokens to a plurality of combinations including possible actions from the action space data object.

In some embodiments, the term “decision support machine learning model framework” refers to a data construct that describes parameters, hyperparameters, and/or defined operations of a machine learning model that is configured to receive an input temporal sequence including a plurality of tuple data objects, generate a plurality of input tokens associated with the plurality of tuple data objects, the plurality of tokens generated according to a plurality of respective tuple data object types associated with the plurality of tuple data objects, generate, using a causal transformer machine learning model, a prediction output based on the plurality of input tokens and a conditional distribution of actions, generate one or more policy scores based on the prediction output, and initiate the performance of one or more prediction-based actions based on the one or more policy scores and the prediction output.

In some embodiments, the term “causal transformer model” refers to a data construct that describes parameters, hyperparameters, and/or defined operations of a machine learning model that is configured to predict one or more next elements (e.g., tuples) of a temporal sequence based on input of one or more previous elements of the temporal sequence. According to various embodiments of the present disclosure, a causal transformer model may predict a next tuple (e.g., including one or more output states, output combinations of actions, output outcomes, and/or an output cumulative discounted future outcome) of a temporal sequence based on one or more input tuples (e.g., each input tuple including one or more states, combinations of actions, outcomes, and/or an cumulative discounted future outcome associated with an encounter instance) of the temporal sequence. A causal transformer machine learning model may further predict additional tuples by iteratively adding predicted tuples to the temporal sequence using the updated temporal sequence as input for prediction of the additional tuples. In some examples, a causal transformer model may be trained based on using one or more reinforcement training techniques, such as teacher-forcing training by using one or more ground-truth tokens as training feedback input to the causal transformer model. In addition, or alternatively, a causal transformer model may be trained by optimizing composite loss function using one or more techniques of the present disclosure. In this regard, the causal transformer model may not receive rewards as part of its input. Instead, rewards may be used to generate an expected outcome loss of the composite loss function.

In some embodiments, a causal transformer model includes a generative pre-trained transformer machine learning model. In some embodiments, training a causal transformer model includes (a) projecting a plurality of training tokens into a plurality of respective embedding spaces using an embedding layer, wherein (i) at least one of the plurality of respective embedding spaces includes a plurality of embedding sets associated with the plurality of training tokens, (ii) the plurality of embedding sets includes a temporal embedding set, a structural embedding set, and a positional embedding set. (iii) the plurality of training tokens is associated with a plurality of training temporal sequences, and (iv) at least one of the plurality of training temporal sequences include one or more training tuples, wherein each training tuple may include a plurality of training tuple data objects including data representative of (1) one or more training states, (2) one or more training combinations of actions, (3) one or more training outcomes associated with a given one of the one or more training states proceeding a respective one of the one or more training combinations of actions, and/or (4) a training cumulative discounted future outcome associated with a given one of the one or more training tuples within the at least one of plurality of training temporal sequences, (b) inputting the plurality of respective embedding spaces into the causal transformer machine learning model, and (c) for at least one of the one or more training tuples, generating a context dependent representation based on one or more of the plurality of respective embedding spaces associated with sequentially prior ones of the one or more training tuples with respect to the at least one training tuple in the training temporal sequence. In some embodiments, during training, a training cumulative discounted future outcome may be masked to prevent leakage of information from the future while learning to predict an output combination of actions {a_{t′}}_{t′=t+1}^{T} or an output state {s_{t′}}_{t′=t+1}^{T}.

In some embodiments, the term “prediction output” refers to a data construct that describes output generated by a causal transformer model. According to various embodiments of the present disclosure, a causal transformer model may generate a prediction output based on a plurality of input tokens and/or a conditional distribution of actions. A prediction output may include a plurality of output tokens. In some examples, the plurality of output tokens may include one or more output state tokens (representative of one or output states), one or more output combinations of actions tokens (representative of one or more output combinations of actions), one or more output outcome tokens (representative of one or more output outcomes), and/or an output cumulative discounted future outcome token (representative of an output cumulative discounted future outcome).

In some embodiments, generating the prediction output includes generating one or more log-likelihood scores of one or more output combinations of actions associated with the one or more output combinations of actions tokens, wherein the log-likelihood scores are representative of a likelihood of the one or more output combinations of actions most likely to follow based on an input temporal sequence. In some examples, generating the prediction output may include generating one or more predictive scores, wherein the one or more predictive scores include (i) one or more action predictive scores of one or more output combinations of actions associated with the one or more output combinations of actions tokens based on the one or more states and/or (ii) one or more outcome predictive scores associated with an output cumulative discounted future outcome associated with the output cumulative discounted future outcome token based on the one or more output combinations of actions. In some examples, generating the prediction output may include generating one or more expected predicted outcomes based on the output cumulative discounted future outcome and the one or more predictive scores.

In some embodiments, the term “policy score” refers to a data construct that describes an evaluative quantification of an action (or a combination of actions) representative of a suggestion of the action (or combination of actions). According to various embodiments of the present disclosure, one or more policy scores may be generated for one or more respective combinations of actions associated with a prediction output generated by a causal transformer machine learning model. In some embodiments, the performance of one or more prediction-based actions may be initiated based on the one or more policy scores and the prediction output. In some embodiments, one or more output combinations of actions (e.g., associated with one or more output combination of actions tokens of a prediction output generated by a causal transformer machine learning model) may be selected for recommendation based on one or more policy scores.

In some embodiments, the term “temporal embedding set” refers to a data construct that describes one or more embeddings associated with a relative time between one of a plurality of training tuple data objects and a sequentially first one of the plurality of training tuple data objects in one of a plurality of training temporal sequences.

In some embodiments, the term “structural embedding set” refers to a data construct that describes one or more embeddings associated with a plurality of respective tuple data object types of a plurality of training tuple data objects.

In some embodiments, the term “positional embedding set” refers to a data construct that describes one or more embeddings associated with a sequential position of one of a plurality of training tuple data objects in one of a plurality of training temporal sequences.

In some embodiments, the term “context dependent representation” refers to a data construct that describes an attention mechanism applied in a causal transformer machine learning model for weighting training tuples within a training temporal sequence during training of the causal transformer machine learning model. A causal transformer machine learning model may use a context dependent representation to interpret data from one or more training tuples for generating a prediction output. According to various embodiments of the present disclosure, for at least one (e.g., a training interval) of one or more training tuples, a context dependent representation may be generated based on one or more of the plurality of respective embedding spaces associated with sequentially prior ones of the one or more training tuples with respect to the at least one training tuple in the training temporal sequence.

In some embodiments, the term “composite loss function” refers to a multi-dimensional loss function that generates a composite loss metric for a machine learning model. The composite loss metric, for example, may include a combination of multiple loss functions. For example, the composite loss metric may balance an imitation loss with an expected outcome loss to optimize a model with respect to both imitation and a reward-based outcome metrics. By way of example, the composite loss function may be defined as follows:

L=Lᵢₘᵢₜₐₜᵢₒₙ+λ·L_{expected-outcome}

where λ may be a hyper-parameter used to configure a degree to which the causal transformer model is encouraged to optimize for future outcomes while deviating from observed actions that are captured by the imitation loss. In some examples, to find a robust value for λ, bootstrapping is used to choose the λ values that produced the highest low confidence interval (2.5%) on the validation set.

In some embodiments, the term “expected outcome loss” refers to a loss metric for a machine learning model. The expected outcome loss, for example, may measure a distance between prediction outputs of a machine learning model and an optimal future outcome. For example, an expected outcome loss may be generated using importance sampling theory and/or may be defined as follows:

$${L}_{expected - outcome} = {\sum }_{i = 0}^{N} {w}_{i} {R}^{( i )}$$

$${w}_{i} = {\prod }_{t = 0}^{{T}_{i}} \frac{∅ ( {a}_{t , i} \vert {s}_{t - 1 , i} , {a}_{t - 1 , c} c )}{{π}_{o} ( {a}_{t , i} , {s}_{t , i} \vert {s}_{t - 1 , i} , {a}_{t - 1 , i} )}$$

where Ø₇₄(a_{t,i}|s_{t-1,i}, a_{t-1,i}, c) is a transformer probability score for the aₜ token for an entity, i, given additional context tokens, c (e.g., demographic variables, etc.), and πₒ(a_{t,i}, s_{t,i}|s_{t-1,i}, a_{t-1,i}) is the observed conditional probability for the at token for the entity, i—both conditioned on the state sₜ₋₁ and aₜ₋₁. wᵢ may include an importance weight for entity, i, calculated as the product of ratios between the prediction outputs and observed probabilities and R⁽ⁱ⁾ may be the total discounted reward for an entity computed as the discounted sum of entity, i, rewards with discount factor γ. In this way, the expected outcome loss may encourage recommend actions that yield high rewards. In some embodiments, the observed conditional probability πₒ(a_{t,i}, s_{t,i}|s_{t-1,i}, a_{t-1,i}) may be replaced with a more general term ψ_{θ′}(a_{t,i}) generated by a second machine learning model, such as a machine learning imitation model that is trained using only an imitation loss to represent a more general probability score that is conditioned on the entire history up to time t rather than a conditional probability.

In some embodiments, the term “imitation loss” refers to a loss metric for a machine learning model. The imitation loss, for example, may measure a distance between prediction outputs of a machine learning model and an imitation output indicative of observed actions from a domain policy. For example, a cross-entropy loss may be predicted using a prediction output and an observed action for an input token sₜ. These losses may be averaged across all time steps for all training entities to generate the imitation loss.

In some embodiments, the term “reward measure” refers to a data construct that describes an impact of an outcome. A reward measure, for example, may be represented by an outcome token, rₜ, that is derived from an outcome, such as a medical outcome in a clinical domain. By way of example, in a clinical domain, a hospitalization or emergency room visit may be assigned a reward measure of −1 if such an event occurred during the encounter and/or a 0 otherwise. As another clinical example, in the case of diabetic severity level, a reward measure may be set +k if the severity level decreased by k levels, and −k if it increased by k levels. In addition, or alternatively, for heart failure severity level, a reward measure may be set to +k if the severity level decreased by k levels and −k if it increased by k levels.

In some embodiments, the term “discounted reward” refers to a data construct that describes a total discounted reward measure for an entity. For example, the discounted reward, R⁽ⁱ⁾, may be the total discounted reward for an entity computed as a discounted sum of entity i rewards with a discount factor γ. By way of example, the discounted reward may be defined as follows:

$${R}^{( i )} = {\sum }_{t = 0}^{{T}_{i}} {γ}^{t} {r}_{t , i}$$

### IV. Overview

Various embodiments of the present disclosure make important technical contributions to improving predictive accuracy of causal transformer machine learning models by leveraging a composite loss metric tailored to a prediction domain. Traditional machine learning techniques, such as decision transformers and trajectory transformers, only optimize indirectly for an expected outcome. For example, in its learning process, a decision transformer optimizes for the actions observed in the data, in effect doing behavioral cloning. In contrast, a trajectory transformer does not optimize directly for the expected outcome. Instead, it learns to predict the reward and likely actions. Given the likely actions it then uses beam search to identify the trajectory that produces the highest reward. Both approaches have significant technical challenges that reduce the reliability, predictive accuracy, and consistency of predictions generated for a prediction domain. For example, while reliable a decision transformer is limited to observed historical behavior that may lack accuracy or fail to achieve an optimal decision. On the other hand, trajectory transformers may anticipate better predictions; however, such predictions are unreliable and may fail to account for significant costs associated with a prediction. Some of the techniques of the present disclosure improved upon such traditional predictive technique by training a machine learning model that directly optimizes an expected outcome through a composite loss function that incorporates weighted importance sampling.

In some embodiments, the composite loss function generates a composite loss metric for machine learning model that combines imitation with an expected outcome loss metrics to train reward-based predictions that are ground in reliable domain standards. In this manner, the reliability of predictions output by a machine learning model may be improved, while allowing the model to anticipate optimal, unobserved predictions within a prediction domain. This in turn, improved the performance of various machine learning technologies, including causal transformer models. Such model may be practically applied in various prediction domain, such as a clinical domain in which the techniques may support improved clinical recommendation engines in cases where domain policies, such as CPGs are not fully defined or integrated in polychronic settings. This is accomplished by learning personalized treatment pathways and thus absorbing warranted deviations and reducing uncertainty in treatment options.

Examples of technologically advantageous embodiments of the present disclosure include: (i) machine learning training techniques for improving transformer models and (ii) inference techniques for generated enhanced prediction outputs among other aspects of the present disclosure. Other technical improvements and advantages may be realized by one of ordinary skill in the art.

### V. Example System Operations

As indicated, various embodiments of the present disclosure make important technical contributions to improving predictive accuracy of causal transformer machine learning models by using a composite loss metric to balance countervailing goals within a prediction domain. Using some of the techniques of the present disclosure, machine learning models may be trained to optimize reward-based outputs that are grounded by trusted domain policies within a prediction domain. In this manner, new prediction outputs may be generated that improve desired outcome without a loss of reliability.

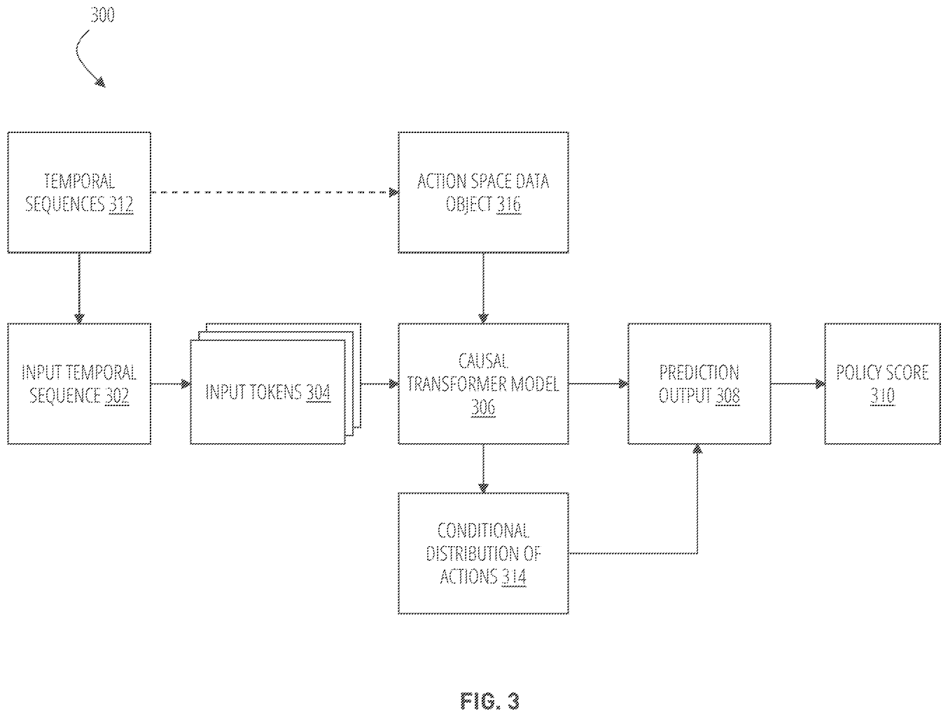

FIG. 3 is a dataflow diagram 300 showing example data structures and modules for performing predictive operations on an input temporal sequence in accordance with some embodiments discussed herein. In some embodiments, a computing system (e.g., computing system 100, etc.) may leverage a decision support machine learning model framework to generate a prediction output 308 for an entity based on an input temporal sequence 302. The prediction output 308 may be leveraged to generate policy scores 310 for selecting an action to improve a desired outcome for the entity.

In some embodiments, an input temporal sequence 302 is received for the entity. The input temporal sequence 302 may include one or more input tuples and at least one of the one or more input tuples may include a plurality of tuple data objects. The plurality of tuple data objects may include data representative of one or more states, one or more combinations of actions, one or more outcomes, and/or a cumulative discounted future outcome associated with the at least one of the one or more input tuples within the input temporal sequence 302.

In some embodiments, the input temporal sequence 302 is a temporal sequence 312 that corresponds to a respective entity. A temporal sequence 312, for example, may describe a time series of one or more tuples associated with instances of encounters with an entity. For example, a temporal sequence 312 may include a sequence of one or more tuples. In some embodiments, a temporal sequence 312 may be provided to as a prediction input to a decision support machine learning model framework that includes a causal transformer model 306 to generate a prediction output 308 based on the temporal sequence 312. A temporal sequence 312 may include data from images, text files, audio/video files, application files, and/or the like. In some examples, an entity may include a computing device and/or a temporal sequence 312 may be generated from a system log including a time series of a plurality of tuple data objects associated with a computing device's history of encounters (e.g., incidents, interactions, data access/modifications, infiltrations, data exfiltration, etc.). In some examples, the entity may depend on the prediction domain. For example, in a clinical domain, an entity may include a medical patient and a temporal sequence 312 may be derived, generated, and/or the like from electronic health records (EHRs) for the entity that include a time series of a plurality of tuple data objects associated with a patient's history of encounters (e.g., visits, admissions, meetings, etc.).

In some embodiments, a temporal sequence 312 is representative of an entity's trajectory with respect to a measured aspect of a prediction domain. For example, in a clinical domain, a temporal sequence 312 may represent an entity's health trajectory with respect to a particular condition, treatment, outcome, and/or the like over multiple clinical encounters. In some examples, each tuple of the temporal sequence may represent an encounter of an entity's trajectory such that a temporal sequence may be represented as:
τ={c,{sₜ, aₜ, rₜ}ₜ₌₀^{T}}where an encounter at time t (e.g., aggregated encounters over a month) may be converted into the tuple (sₜ, aₜ, sₜ) which, in a clinical domain, records an entity's physiological state (sₜ∈S), an action token representing one or more actions that were taken during the encounter (aₜ∈A), and an outcome (rₜ−R). In some examples, an additional token c∈C is added to represent static information for an entity, such as a patient's age, sex, demographics, and/or the like in a clinical domain. In some examples, the temporal sequence 312 may include a plurality of sequential tuples for an entity that includes a respective tuple for one or more time segments within an evaluation time period T. Each time segment, for example, may include a month of an evaluation time period. In some examples, the evaluation time period may include a two year time period such that the temporal sequence 312 may include a maximum of twenty-four tuples for the entity.

In some embodiments, a tuple describes an element of a temporal sequence 312. For example, a tuple may include a plurality of tuple data objects that include data representative of one or more states, combinations of actions, outcomes, cumulative discounted future outcomes, and/or the like for an entity. In some examples, the plurality of tuple data objects may include one or more tokens, such as a state token, sₜ, an action token, aₜ, outcome token, rₜ, and/or the like. For example, an encounter instance may be represented by a tuple that includes a plurality of tuple data objects in the form (sₜ, aₜt, rₜ). Relative to a timestamp (t), a state token, s, may be indicative of a state for an entity (e.g., a computing device state, a diagnostic code, a physical/physiological state, etc.), an action token, a, may be indicative of one or more actions and/or action combinations for the entity, and a outcome token, r, may be indicative of one or more outcomes (e.g., increase in computing device performance, an improvement in condition, a reduction in disease severity, inpatient stay occurring, etc.) after the one or more actions a are taken. In some examples, a plurality of tuple data objects may include a cumulative discounted future outcome, Rₜ, such that the tuple has the form of (sₜ, aₜ, rₜ, Rₜ). A cumulative discounted future outcome may include a sum of all discounted future outcomes in a temporal sequence 312 associated with a tuple. In some embodiments, the cumulative discounted future outcome may be determined with a discount factor γ, e.g., Rₜ=Σ_{t′=t}^{T}γ^{t′}r_{t′}. In another embodiment, the cumulative discounted future outcome may be windowed with a horizon parameter w. e.g., Rₜ=Σ_{t′=t}^{t+w}r_{t′}.

In some examples, the tuple may correspond to a time segment of an evaluation time period defined by the temporal sequence 312. In some examples, a tuple may define data that is representative of one or more encounter instances within a time segment of an evaluation time period. By way of example, one or more encounter instances that occur within a single time segment (e.g., a week, month, etc.) may be aggregated into a singular encounter. In terms of actions, this implies that all distinct actions that occurred within the same time segment may be included as part of the same encounter. For outcomes, a highest recorded outcome (e.g., severity level, etc.) within the time segment may be used as the outcome for the encounter. In this manner, actions and outcomes may be consolidated to provide a concise representation of the data, allowing for statistical signal processing through machine learning while retaining temporal information.

In some embodiments, a tuple data object describes an attribute of a tuple associated with an encounter instance within a temporal sequence 312. For example, a tuple of a temporal sequence 312 may include a plurality of tuple data objects including data representative of (i) one or more states, (ii) one or more actions and/or combinations thereof, and/or (iii) one or more outcomes associated with a given one of the one or more states proceeding a respective one of the one or more actions. In some examples, a tuple data object may include data representative of a cumulative discounted future outcome. A plurality of tuple data objects within a temporal sequence 312 may be internally related and/or include correlations of various degrees that may be interpreted with various meanings. For example, a tuple may represent a computing device incident on a given date and include a plurality of tuple data objects including data representative of one or more computing device status (state), one or more combination of actions, one or more computing device outcomes, and/or a cumulative discounted future computing device outcome associated with the computing device incident. As another example, a tuple may represent a patient admission on a given date and include a plurality of tuple data objects including data representative of one or more patient conditions (state), one or more combination of treatments (combination of actions), one or more clinical outcomes, and/or a cumulative discounted future clinical outcome associated with the patient admission.

As described herein, in accordance with various embodiments of the present disclosure, a causal transformer model 306 may be trained to predict sequence elements following one or more prior sequence elements of a temporal sequence 312 provided as input to the causal transformer model 306. A sequence element may include a tuple including a plurality of tuple data objects including data representative of states, combinations of actions, outcomes, and/or cumulative discounted future outcomes. As such, a sequence element may be used to represent a trajectory of events that occur sporadically, exhibit co-occurrences as dictated by situation, and/or occur at variable lengths of time between a first encounter and a last encounter. Accordingly, training the causal transformer model 306 may include projecting a plurality of training tokens into a plurality of respective embedding spaces including a temporal embedding set, a structural embedding set, and/or a positional embedding set to capture the sporadicity of sequence elements as well as to account for heterogeneity in encounter patterns to differentiate between consecutive sequence elements that happen within a short timeframe to those that happened within a long timeframe. This technique may lead to higher accuracy of performing predictive operations as needed on certain sets of data and enable the causal transformer model 306 to accurately predict future outcomes and a best combination of actions.

In some embodiments, a plurality of input tokens 304 associated with a plurality of tuple data objects of the input temporal sequence 302 may be generated for an entity. The plurality of input tokens 304 may be generated according to a plurality of respective tuple data object types associated with the plurality of tuple data objects. In some examples, a token may describe a unique representation of a tuple data object in a format suitable for processing by a machine learning model. For example, a token may include one or more integers and/or characters representative of features of a tuple data object. A token may be formatted according to integer values, binary values, hexadecimal values, and/or the like. A tuple data object may be converted into a token using a predefined mapping of features associated with the tuple data object to the token. In some embodiments, generating the plurality of input tokens 304 may include receiving an action space data object that includes a plurality of possible individual actions and assigning a plurality of action tokens to a plurality of combinations of selected ones of the plurality of possible individual actions.

In some embodiments, an input token 304 is generated for a tuple data object based on its tuple data object type (e.g., state, actions, outcome, cumulative discounted future outcome, and/or the like) represented by the tuple data object. A tuple, for example, may include a state token corresponding the state tuple data object, an action token corresponding to an action tuple data object, an outcome token corresponding to an outcome tuple data object, and/or the like. For example, an action token may be assigned to each specific combination of actions (e.g., individual, pairwise, or higher order) in a tuple that includes one or more tuple data objects including data representative of one or more combinations of actions. In some examples, a state token may be assigned to each state in a tuple including one or more tuple data objects including data representative of one or more states (e.g., a unique token for physiological state, etc.). In some examples, an outcome token may be assigned to each outcome and/or discounted future outcome in a tuple including one or more tuple data objects including data representative of one or more outcomes and/or discounted future outcomes. In some examples, tokenizing discounted future outcomes may include sampling the discounted future outcomes into discrete values by dividing the discount outcomes into M quantiles and mapping each quantile into a single token.

In some embodiments, the input tokens 304 are processed, using the causal transformer model 306, to generate a prediction output 308 based on the plurality of input tokens 304. In some examples, the prediction output 308 may be based on a conditional distribution of actions.

In some embodiments, a conditional distribution of actions 314 describes a distribution of probability values associated with occurrence of a plurality of actions. In some embodiments, the conditional distribution of actions 314 may be generated based on one or more states associated with a temporal sequence 312. In some embodiments, the conditional distribution of actions 314 may be generated by determining, for one or more states associated with a tuple of a temporal sequence 312, a number of action combination tokens that are present within the tuple associated with tuple data objects including data representative of a specific state. In some embodiments, one or more of the plurality of action combination tokens may be excluded from the conditional distribution of actions 314 based on the excluded one or more action combination tokens including probability scores below a threshold. In some embodiments, the excluded one or more of the plurality of action combination tokens may be replaced with one or more action combination tokens including most frequent actions or actions coincident with the largest number of action combination tokens that are present within the tuple that are similar to the excluded one or more of the plurality of action combination tokens.

In some embodiments, an action space data object 316 describes a list of individual actions including possible actions that may exist in combinations of actions associated with training temporal sequences and/or used to generate a prediction output 308 by a causal transformer model 306. For example, an action space data object 316 may be generated based on expert knowledge data, guidelines data, or databases associated with a given subject matter or including actions that may be present in temporal sequences 312. In some embodiments, an action space data object 316 may be used to assign a plurality of action combination tokens to a plurality of combinations including possible actions from the action space data object 316.

In some embodiments, a causal transformer model 306 describes parameters, hyperparameters, and/or defined operations of a machine learning model that is configured to predict one or more next elements (e.g., tuples) of a temporal sequence 312 based on input of one or more previous elements of the temporal sequence 312. According to various embodiments of the present disclosure, a causal transformer model 306 may predict a next tuple (e.g., including one or more output states, output combinations of actions, output outcomes, and an output cumulative discounted future outcome) of a temporal sequence 312 based on one or more input tuples (e.g., each input tuple including one or more states, combinations of actions, outcomes, and an cumulative discounted future outcome associated with an encounter instance) of the temporal sequence 312. A causal transformer model 306 may further predict additional tuples by iteratively adding predicted tuples to the temporal sequence 312 using the updated temporal sequence 312 as input for prediction of the additional tuples. In some examples, a causal transformer model 306 may be trained based on using one or more reinforcement training techniques, such as teacher-forcing training by using one or more ground-truth tokens as training feedback input to the causal transformer model 306. In addition, or alternatively, a causal transformer model 306 may be trained by optimizing composite loss function using one or more techniques of the present disclosure. In this regard, the causal transformer model 306 may not receive rewards as part of its input. Instead, rewards may be used to generate an expected outcome loss of the composite loss function.

In some embodiments, a prediction output 308 describes output generated by a causal transformer model 306. In some examples, the prediction output 308 may include a probability score for an action of a plurality of actions defined by the action space data object 316. A prediction output 308 may include a plurality of output tokens. In some examples, the plurality of output tokens may include one or more output state tokens (representative of one or output states), one or more output combinations of actions tokens (representative of one or more output combinations of actions), one or more output outcome tokens (representative of one or more output outcomes), and an output cumulative discounted future outcome token (representative of an output cumulative discounted future outcome).

In some examples, generating the prediction output 308 may include generating one or more log-likelihood scores of one or more output combinations of actions associated with the one or more output combinations of actions tokens, wherein the log-likelihood scores are representative of a likelihood of the one or more output combinations of actions most likely to follow based on an input temporal sequence 302 302. As an example, for a sequence τ of length T, a prediction output 308 of the causal transformer model 306 with parameters θ may include the induced log-likelihood:

$${ℓℓ}_{θ} ( τ ) = {\sum }_{t = 1}^{T} ( {\sum }_{i = 1}^{M} log {P}_{θ} ( {s}_{t}^{i} \vert {s}_{t}^{< i} , {τ}_{< t} ) + log {P}_{θ} ( {a}_{t} \vert {s}_{t} , {τ}_{< t} ) + log {P}_{θ} ( {R}_{t} \vert {s}_{t} , {a}_{t} , {τ}_{< t} ) ) \qquad Equation 1$$

In the above equation, M may represent the states dimension and τ_{<t} may represent all items of the sequence τ that appeared before time t. Using this property, it is possible to generate log-likelihood scores that are attribute specific such as the following actions log-likelihood:

$${ℓℓ}_{θ}^{𝒜} ( τ ) = {\sum }_{j = t}^{T} log {P}_{θ} ( {a}_{t} \vert {s}_{t} , {τ}_{< t} ) \qquad Equation 2$$

Assuming statistical independence between temporal sequences, log-likelihood scores for an entire cohort D may be generated by the following Equations 3 and 4:

$${ℓℓ}_{θ} ( D ) = {\sum }_{i = 1}^{N} {ℓℓ}_{θ} ( {τ}^{( i )} ) \qquad Equation 3$$

$${ℓℓ}_{θ}^{𝒜} ( D ) = {\sum }_{i = 1}^{N} {ℓℓ}_{θ}^{𝒜} ( {τ}^{( i )} ) \qquad Equation 4$$

In Equations 3 and 4, τ⁽ⁱ⁾ may represent a temporal sequence 312 of the i-th entity (e.g., computing device, subject, patient) and N may represent the number of entities in the cohort.

In some examples, generating the prediction output 308 may include generating one or more predictive scores, wherein the one or more predictive scores includes (i) one or more action predictive scores of one or more output combinations of actions associated with the one or more output combinations of actions tokens based on the one or more states, and (ii) one or more outcome predictive scores associated with an output cumulative discounted future outcome associated with the output cumulative discounted future outcome token based on the one or more output combinations of actions.

The following Equations 5 and 6 may be used to generate prediction scores for actions and outcomes, respectively:

[symbol]

_{θ}(aₜ;sₜ,τ_{<t})=P_{θ}(aₜ|sₜ,τ_{<t}) Equation 5

[symbol]

_{θ}(Rₜ;aₜsₜ,τ_{<t})=P_{θ}(Rₜ|aₜ,sₜ,τ_{<t}) Equation 6

The above prediction scores may represent an estimated predictive distribution induced by the causal transformer model 306 for observing different actions or outcomes (respectively) at time t given previously observed trajectory τ_{<t}, and current available data (e.g., from the input temporal sequence 302).

In some examples, generating the prediction output 308 may further include generating one or more expected predicted outcomes based on the output cumulative discounted future outcome and the one or more predictive scores. In some embodiments, at least one sequentially first ones of the one or more training tuples may be discarded from one or more of the plurality of training temporal sequences.

Using the outcome prediction score [symbol] _{θ}(Rₜ; aₜ, sₜ, τ_{<t}) described above, an estimated expected outcome \hat{R}ₜ may be obtained for entity i with temporal sequence 312 τ^{(t)}, state sₜ, and actions at according to the following:

\hat{R}ₜ=\hat{R}(aₜ;sₜ,τ_{<t})= [symbol] [R_{θ}(aₜ;sₜ, τ_{<t})]= [symbol] Rₜ· [symbol] _{θ}(Rₜ;aₜ, sₜ, τ_{<t}) Equation 7

In the above equation, [symbol] may represent all possible outcomes and [symbol] _{θ}(Rₜ; aₜ, sₜ, τ_{<t}) may represent the estimated probability to observe cumulative discounted future outcome R induced by the causal transformer model 306.

In some embodiments, one or more policy scores 310 are generated based on the prediction output 308. In some examples, a policy score 310 describes an evaluative quantification of an action (or a combination of actions) representative of a suggestion of the action (or combination of actions). In some examples, one or more policy scores 310 may be generated for one or more respective combinations of actions associated with a prediction output 308 generated by a causal transformer model 306. In some examples, the performance of one or more prediction-based actions may be initiated based on the one or more policy scores 310 and the prediction output 308. In some examples, one or more output combinations of actions (e.g., associated with one or more output combination of actions tokens of a prediction output 308 generated by a causal transformer model 306) may be selected for recommendation based on one or more policy scores 310.

In some embodiments, the one or more policy scores 310 are generated by obtaining a predictive score, such as a log-likelihood score, for each possible action and identifying actions that are likely to appear in a next step of a sequence including a combination of the possible actions. Predictive scores for a plurality of possible combinations of actions are used to generate an action prediction probability distribution. Selected ones of the plurality of combinations of actions may be sampled from the action prediction probability distribution and expected predicted outcomes (e.g., generated by a causal transformer model 306 as a prediction output 308) may be determined for each sampled combination of actions. In some examples, selection of the combinations of actions for sampling may be based on the selected combinations of actions including predictive scores that satisfy a given probability threshold. In another embodiment, the selected combinations of actions may be selected randomly or semi-randomly. One or more policy scores 310 may be generated as a probability distribution over the selected combinations of actions sorted by outcome, for example, using the following equation:

$${π}^{*} ( {a}_{t} ; {s}_{t} , {τ}_{< t} ) = \{ \begin{matrix}softmax ( \hat{R} ( {a}_{t} ; {s}_{t} , {τ}_{< t} ) ) {a}_{t} ∈ {\hat{𝒜}}_{t}^{( i )} \\ ϵ {a}_{t} ∉ {\hat{𝒜}}_{t}^{( i )}\end{matrix} \qquad Equation 8$$

According to Equation 8, each action at may be assigned with a suggestion score π(aₜ; sₜ, τ_{<t}) representative of how likely the action is to be performed given current state sₜ and the quality of the expected future outcome \hat{R} if the given action is performed. As such, the one or more policy scores 310 may be used to determine combinations of actions including the best predicted outcomes.

In some embodiments, the performance of one or more prediction-based actions may be initiated based on the one or more policy scores 310 and/or the prediction output 308. Initiating the performance of the one or more prediction-based actions includes, for example, performing a resource-based action (e.g., allocation of resource), generating a diagnostic report, generating action scripts, generating alerts or messages, and/or generating one or more electronic communications. The one or more prediction-based actions may further include displaying visual renderings of the aforementioned examples of prediction-based actions in addition to values, charts, and representations associated with the one or more policy scores 310 and the prediction output 308 using a prediction output 308 user interface.

An example of a prediction-based action, for example, may include troubleshooting a computing device based on a system log by predicting one or more diagnostic codes, one or more remedies (or a combination of remedies), one or more outcomes associated with performing the one or more remedies, and/or a cumulative discounted future outcome, displaying the one or more diagnostic codes, remedies, outcomes, and cumulative discounted future outcome on a user interface, and performing the one or more remedies. Another example of a prediction-based action that may be performed includes treating a patient based on electronic health record (EHR) data by predicting a patient's physiological state, a combination of treatments, one or more clinical outcomes associated with performing the combination of treatments, and a cumulative discounted future clinical outcome, displaying the physiological state, combination of treatments, clinical outcomes, and cumulative discounted future outcome on a user interface, and electronically facilitating the combination of treatments (e.g., communication, scheduling, or allocating resources).

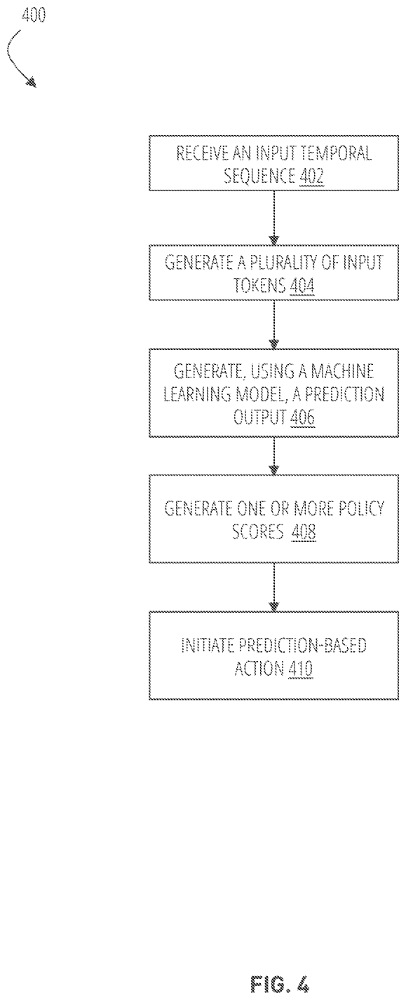

FIG. 4 is a flowchart diagram of an example process 400 for performing predictive operations on an input temporal sequence in accordance with some embodiments of the present disclosure. The flowchart depicts a prediction process for generating an enhanced prediction based on sequential information for an entity. The process 400 may be implemented by one or more computing devices, entities, and/or systems described herein. For example, via the various steps/operations of the process 400, the computing system 100 may leverage a causal transformer model to generate prediction outputs for a prediction domain. Unlike traditional predictive modeling techniques, the causal transformer model may be capable of interpreting dense input temporal sequences for an entity that include inconsistent datasets of contextual information over time.

FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence.

In some embodiments, the process 400 includes, at step/operation 402, receiving an input temporal sequence. For example, the computing system 100 may receive the input temporal sequence. The input temporal sequence may include one or more input tuples, at least one of the one or more input tuples including a plurality of tuple data objects including data representative of (a) one or more states, (b) one or more combinations of actions, (c) one or more outcomes, and/or (d) a cumulative discounted future outcome associated with the at least one of the one or more input tuples within the input temporal sequence.

In some embodiments, the process 400 includes, at step/operation 404, generating a plurality of input tokens. For example, the computing system 100 may generate the plurality of input tokens associated with the plurality of tuple data objects, the plurality of tokens generated according to a plurality of respective tuple data object types associated with the plurality of tuple data objects.

In some embodiments, the process 400 includes, at step/operation 406, generating, using a machine learning model, a prediction output. For example, the computing system 100 may generate, using a causal transformer model, a prediction output based on the plurality of input tokens and a conditional distribution of actions, the prediction output including a plurality of output tokens. In some examples, the computing system 100 may generate the conditional distribution of actions based on the one or more states. In some examples, the computing system 100 may receive an action space data object including a plurality of possible individual actions and assign a plurality of action combination tokens to a plurality of combinations including selected ones of the plurality of possible individual actions.

In some examples, the plurality of output tokens includes one or more output state tokens, one or more output action tokens, one or more output outcome tokens, and/or one or more output cumulative discounted future outcome tokens. In some examples, the computing system 100 may exclude one or more of the plurality of action combination tokens from the conditional distribution of actions based on the excluding of one or more action combination tokens including probability scores below a threshold.

In some examples, generating the prediction output further includes generating one or more log-likelihood scores of one or more output actions associated with the one or more output action tokens, the log-likelihood scores representative of a likelihood of the one or more output actions most likely to follow based on the input temporal sequence. In some examples, generating the prediction output further includes generating one or more predictive scores, the one or more predictive scores including (i) one or more action predictive scores of one or more output actions associated with the one or more output action tokens based on the one or more states, and (ii) one or more outcome predictive scores associated with one or more output cumulative discounted future outcomes associated with the one or more output cumulative discounted future outcome tokens based on the one or more output actions. In some examples, generating the prediction output further includes generating one or more expected predicted outcomes based on the one or more output cumulative discounted future outcomes and the one or more predictive scores.

In some examples, training the causal transformer model includes (a) projecting a plurality of training tokens into a plurality of respective embedding spaces using an embedding layer, wherein (i) at least one of the plurality of respective embedding spaces includes a plurality of embedding sets associated with the plurality of training tokens, (ii) the plurality of embedding sets includes a temporal embedding set, a structural embedding set, and a positional embedding set, (iii) the plurality of training tokens is associated with a plurality of training temporal sequences, and (iv) at least one of the plurality of training temporal sequences includes one or more training tuples, wherein at least one of the one or more training tuples includes a plurality of training tuple data objects including data representative of one or more training states, one or more training combinations of actions, one or more training outcomes, and a training cumulative discounted future outcome associated with the at least one of the one or more training tuples within the at least one of plurality of training temporal sequences, (b) inputting the plurality of respective embedding spaces into the causal transformer model, and (c) for at least one of the one or more training tuples, generating a context dependent representation based on one or more of the plurality of respective embedding spaces associated with sequentially prior ones of the one or more training tuples with respect to the at least one training tuple in the training temporal sequence.

In some examples, the temporal embedding set includes one or more embeddings associated with a relative time between one of the one or more training tuples and a sequentially first one of the one or more training tuples in one of the plurality of training temporal sequence. In some examples, the structural embedding set includes one or more embeddings associated with the plurality of respective tuple data object types of the plurality of training tuple data objects. In some examples, the positional embedding set includes one or more embeddings associated with a sequential position of one of the one or more training tuples in one of the plurality of training temporal sequence. In some examples, the computing system may discard at least one sequentially first ones of the one or more training tuples from one or more of the plurality of training temporal sequence. In some examples, the causal transformer model may be trained based on teacher-forcing training by using one or more ground-truth tokens as training feedback input to the causal transformer model.

In some embodiments, the process 400 includes, at step/operation 408, generating one or more policy scores. For example, the computing system 100 may generate the one or more policy scores based on the prediction output.

In some embodiments, the process 400 includes, at step/operation 410, initiating a prediction-based action. For example, the computing system 100 may initiate the performance of one or more prediction-based actions based on the one or more policy scores and the prediction output. For example, the computing system 100 may select one or more output actions associated with the one or more output action tokens based on the policy score.

Accordingly, as described above, various embodiments of the present disclosure make important technical contributions to improving predictive accuracy of causal transformer models by using a combination of temporal, structural, and positional embeddings to characterize temporal sequences including one or more tuples representative of one or more respective encounter instances. This approach improves training speed and training efficiency of training causal transformer models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training causal transformer models, thus reducing the number of computational operations needed and/or the amount of training data entries needed to train causal transformer models. Accordingly, the techniques described herein improve the computational efficiency, storage-wise efficiency, and/or speed of training machine learning models.

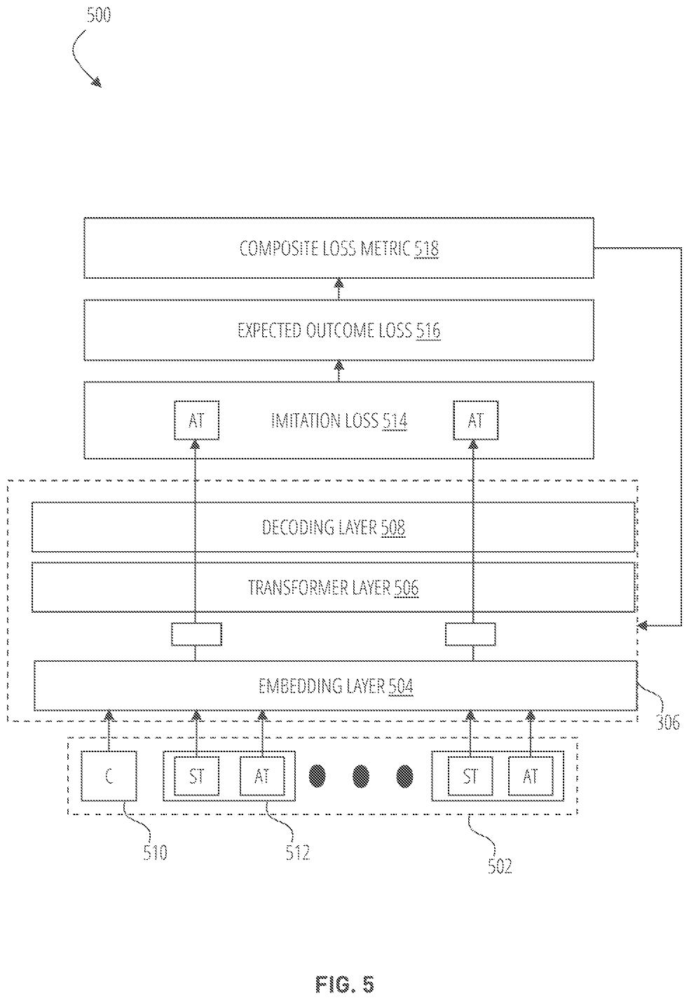

FIG. 5 is a dataflow diagram 500 showing example data structures and modules for a composite training technique in accordance with some embodiments discussed herein. In some embodiments, a computing system (e.g., computing system 100, etc.) may leverage a decision support machine learning model framework to generate a prediction output for an entity based on an input temporal sequence. The machine learning model framework may be utilized a machine learning model, such as the causal transformer model 306 that is trained to generated optimized prediction outputs for an input temporal sequence. To optimize model, the causal transformer model 306 may be trained using a composite loss metric 518 that balances an imitation loss 514 with an expected outcome loss 516 to encourage predictions that optimize a potential reward, while remaining grounded in historical observed actions.

In some embodiments, a plurality of training tuples 512 are received for at least one training entity. The plurality of training tuples 512 may correspond to a training temporal sequence 502 for the training entity. In some examples, the training temporal sequence 502 defines an evaluation time period with a plurality of time segments. A training tuple of the plurality of training tuples 512 may include at least one state token, action token, and/or outcome token for the training entity at a time segment of the plurality of time segments. In some examples, the state tokens may be indicative of one or more states for the training entity. In some examples, the action tokens may be indicative of one or more action combinations for the training entity. In some examples, the outcome tokens may be indicative of one or more outcomes for the training entity. In some examples, the one or more action combinations may correspond to one or more of a plurality of actions defined by an action space data object.

In some examples, the plurality of training tuples 512 are previously generated from a training dataset including a plurality of temporal sequences. For example, one or more action tokens may be generated that each represent a unique combination of actions from an available action space. In some examples, the action tokens may be filtered according to exclusion criteria. In some examples, excluded tokens may be imputed by replacing filtered action tokens with similar non-excluded action tokens.

In some embodiments, the plurality of training tuples 512 (and/or components thereof) are input to the causal transformer model 306 to generate a prediction output for the training entity. In some examples, the prediction output includes a probability score for an action of the plurality of actions defined within an action space data object. The causal transformer model 306 may include an embedding layer 504, a transformer layer 506, and/or a decoding layer 508. In some examples, the transformer layer 506 may include a generative pre-trained transformer.

In some embodiments, the embedding layer 504 translates the plurality of tokens into a real-valued vector such that dense representations of the plurality of tokens are learned in such a way that tokens associated with training tuples co-occurring within a certain window length are closer in vector space than those that are not. The embedding layer may include the following parameters: (a) maximum temporal sequence length, (b) vocabulary size or set of all tokens being embedded, (e.g., for combination of actions tokens—a number of action tokens being considered), (c) a free tuning parameter for the dimensionality of the vector space, and/or the like. In some examples, during training, the reward measures, such as an outcome token, cumulative discounted future outcome, and/or the like may be masked to prevent leakage of information from the future while learning to predict an output combination of actions {a_{t′}}_{t′=t+1}^{T} or an output state {s_{t′}}_{t′=t+1}^{T}.

In some embodiments, at least one sequentially first ones of the training tuples 512 may be discarded from the training temporal sequence 502 to randomize first encounters observed by the causal transformer model 306. Discarding training tuples from the training temporal sequence 502 may improve training and prediction performance due to the variable length nature of temporal sequences. For example, all temporal sequences may include a first tuple but not all of the temporal sequences may include a fifth tuple. By discarding selected training tuples, assignments of first tuples within a plurality of temporal sequences may be randomized to mitigate training on a disproportionate amount of data for the earlier tuples in a sequence.

In some embodiments, at least one of the plurality of respective embedding spaces may include a plurality of embedding sets associated with the plurality of training tokens. In some examples, the plurality of embedding sets may include a temporal embedding set, a structural embedding set, and/or a positional embedding set. A temporal embedding set, for example, may describe one or more embeddings associated with a relative time between one of a plurality of training tuples 512 and a sequentially first one of the plurality of training tuples 512 in the training temporal sequence 502. In some examples, a structural embedding set describes one or more embeddings associated with a plurality of respective tuple data object types of a plurality of training tuple data objects. In some examples, a positional embedding set describes one or more embeddings associated with a sequential position of one of a plurality of training tuples 512 in the training temporal sequence 502.

In some embodiments, the plurality of respective embeddings for the training temporal sequence 502 may be input to a transformer layer 506 of the causal transformer model 306 to generate an encoded prediction output. The encoded prediction output may be decoded by a decoding layer 508 to generate the prediction output.

In some embodiments, a composite loss metric 518 is generated, using a composite loss function, for the causal transformer model 306. The composite loss metric 518, for example, may be based on a first loss metric, such as an expected outcome loss 516, and a second loss metric, such as an imitation loss 514, to create a balanced metric for the causal transformer model 306 that balances a potential reward against an observable result. For example, the first loss metric may include an expected outcome loss 516 that is based on a comparison between the prediction output and a plurality of historical reward measures. In addition, or alternatively, the second loss metric may include an imitation loss 514 that is based on a comparison between the prediction output and an imitation output corresponding to the prediction output. In some examples, the composite loss metric may be further based on a hyper-parameter indicative of a deviation allowance from one or more historical outputs. The one or more historical outputs, for example, may be manually defined by a domain policy (e.g., CPG, etc.).

In some embodiments, the composite loss function is a multi-dimensional loss function that generates a composite loss metric 518 for a machine learning model, such as the causal transformer model 306. The composite loss metric 518, for example, may include a combination of multiple loss functions. For example, the composite loss metric 518 may balance an imitation loss 514 with an expected outcome loss 516 to optimize a model with respect to both imitation and a reward-based outcome metrics. By way of example, the composite loss function may be defined as follows:

L=Lᵢₘᵢₜₐₜᵢₒₙ+λ·L_{expected-outcome} Equation 9

where λ may be a hyper-parameter used to configure a degree to which the causal transformer model is encouraged to optimize for future outcomes while deviating from observed actions that are captured by the imitation loss. In some examples, to find a robust value for λ, bootstrapping is used to choose the λ values that produced the highest low confidence interval (2.5%) on the validation set.

In some embodiments, the first loss metric includes an expected outcome loss 516. The expected outcome loss 516 may be generated based on the prediction output, an importance weight for the training entity, and/or a discounted reward for the training entity that is based on an aggregation of a plurality of reward measures. The plurality of reward measures, for example, may be based on the one or more outcomes of the plurality of training tuples 512.

In some embodiments, a reward measure is a data construct that describes an impact of an outcome. A reward measure, for example, may be represented by an outcome token, rₜ, that is derived from an outcome, such as a medical outcome in a clinical domain. By way of example, in a clinical domain, a hospitalization or emergency room visit may be assigned a reward measure of −1 if such an event occurred during the encounter and/or a 0 otherwise. As another clinical example, in the case of diabetic severity level, a reward measure may be set +k if the severity level decreased by k levels, and −k if it increased by k levels. In addition, or alternatively, for heart failure severity level, a reward measure may be set to +k if the severity level decreased by k levels and −k if it increased by k levels.

In some embodiments, the expected outcome loss 516 is to a loss metric for a machine learning model. The expected outcome loss 516, for example, may measure a distance between prediction outputs of a machine learning model and an optimal future outcome. For example, an expected outcome loss 516 may be generated using importance sampling theory and/or may be defined as follows:

$${L}_{expected - outcome} = \frac{{\sum }_{i = 0}^{N} {w}_{i} {R}^{( i )}}{{\sum }_{i = 0}^{N} {w}_{i}} \qquad Equation 10$$

$${w}_{i} = {\prod }_{t = 0}^{{T}_{i}} \frac{{∅}_{θ} ( {a}_{t , i} \vert {s}_{t - 1 , i} , {a}_{t - 1 , i} , c )}{{π}_{o} ( {a}_{t , i} , {s}_{t , i} \vert {s}_{t - 1 , i} , {a}_{t - 1 , i} )} \qquad Equation 11$$

where Ø_{θ}(a_{t,i}|s_{t-1,i}, a_{t-1,i}, c) is a transformer probability score for the at token for an entity, i, given additional context tokens, c (e.g., demographic variables, etc.), and πₒ(a_{t,i}, s_{t,i}|s_{t-1,i}, a_{t-1,i}) is the observed conditional probability for the at token for the entity, i -both conditioned on the state sₜ₋₁ and aₜ₋₁. wᵢ may include an importance weight for entity, i, calculated as the product of ratios between the prediction outputs and observed probabilities and R⁽ⁱ⁾ may be the total discounted reward for an entity computed as the discounted sum of entity, i, rewards with discount factor γ. In this way, the expected outcome loss may encourage recommend actions that yield high rewards. In some embodiments, the observed conditional probability πₒ(a_{t,i}, s_{t,i}|s_{t-1,i}, a_{t-1,i}) may be replaced with a more general term ψ_{θ′}(a_{t,i}) generated by a second machine learning model, such as a machine learning imitation model that is trained using only an imitation loss to represent a more general probability score that is conditioned on the entire history up to time t rather than a conditional probability.

In some embodiments, a discounted reward is a data construct that describes a total discounted reward measure for an entity. For example, the discounted reward, R⁽ⁱ⁾, may be the total discounted reward for an entity computed as a discounted sum of entity i rewards with a discount factor γ. By way of example, the discounted reward may be defined as follows:

$${R}^{( i )} = {\sum }_{t = 0}^{{T}_{i}} {γ}^{t} {r}_{t , i} \qquad Equation 12$$

In some embodiments, the second loss metric is an imitation loss 514. In some examples, the imitation loss 514 may be based on an imitation output generated by a second machine learning model, such as an imitation model with the same (or similar) architecture as the causal transformer model 306, that is previously trained using an imitation loss function. For example, the imitation loss function may be based on a comparison between a training output and an observed action identified by a domain policy. In this manner, the imitation model may be trained to generate an imitation output that imitates observed actions and/or actions prescribed by a domain policy without consideration of a potential reward associated with the imitation output.

In some embodiments, the imitation loss 514 is a loss metric for a machine learning model. The imitation loss 514, for example, may measure a distance between prediction outputs of a machine learning model and imitation outputs indicative of observed actions from a domain policy. For example, a cross-entropy loss may be predicted using a prediction output and an observed action for an input token sₜ. These losses may be averaged across all time steps for all training entities to generate the imitation loss 514.

In some embodiments, one or more model parameters of the causal transformer may be modified based on the composite loss metric. By way of example, the model parameters may be interactively modified over a plurality of training operations to optimize the composite loss metric 518. In this manner, the causal transformer model 306 may learn to generate prediction outputs that maximize a potential reward, while remaining grounded in observed actions.

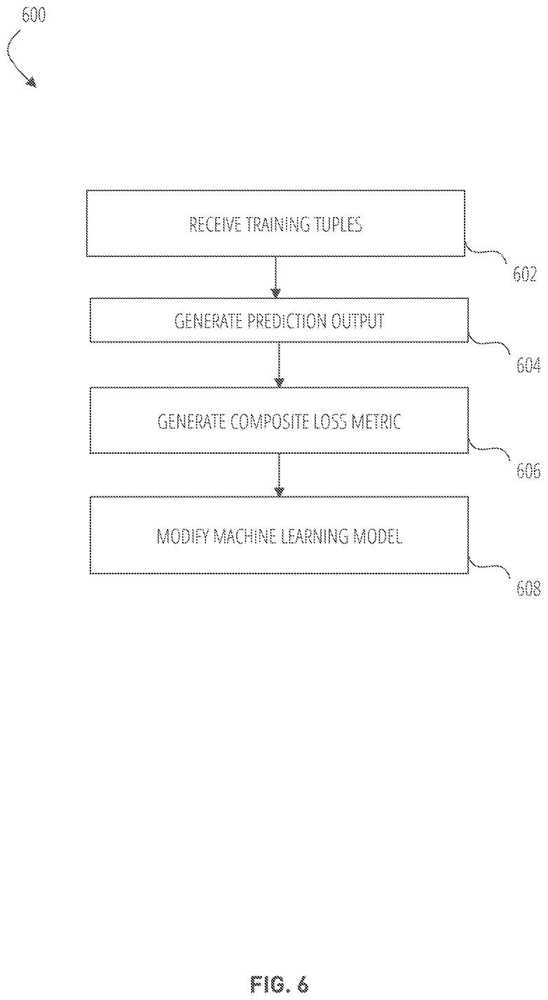

FIG. 6 is a flowchart diagram of an example process 600 for training a machine learning model in accordance with some embodiments of the present disclosure. The flowchart depicts a training process for generating an enhanced machine learning model that is capable of generating prediction outputs that are grounded in observed actions while considering potential rewards. The process 600 may be implemented by one or more computing devices, entities, and/or systems described herein. For example, via the various steps/operations of the process 600, the computing system 100 may generate, leverage, and/or monitor the performance of a machine learning model to improving prediction outputs for any prediction domain by tailoring predictions to domain standards while considering rewarded behavior over time. By way of example, unlike traditional predictive techniques, a causal transformer model trained through the steps/operations of process 600 may be capable of generating accurate and reliable outputs that may identify highly rewarded activity, while being grounded by traditional tested and verified domain standards.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, receiving training tuples. For example, the computing system 100 may receive the plurality of training tuples for a training entity. In some examples, the plurality of training tuples corresponds to a training temporal sequence for the training entity, the training temporal sequence defines an evaluation time period with a plurality of time segments, and a training tuple of the plurality of training tuples includes a state token, an action token, and/or an outcome token for the training entity at a time segment of the plurality of time segments. In some examples, the state token may be indicative of a state for the training entity, the action token may be indicative of one or more action combinations for the training entity, and the outcome token may be indicative of one or more outcomes for the training entity. In some examples, the one or more action combinations may correspond to one or more of a plurality of actions defined by an action space data object.

In some embodiments, the plurality of training input tuples is previously generated by generating one or more action tokens, each representing a unique combination of actions from an available action space, filtering the action tokens according to exclusion criteria; and imputing excluded tokens by replacing filtered action tokens with similar non-excluded action tokens.

In some embodiments, the process 600 includes, at step/operation 604, generating a prediction output. For example, the computing system 100 may generate, using a first machine learning model, the prediction output for the training entity. The first machine learning model may include a causal transformer model. In some examples, the prediction output includes a probability score for an action of the plurality of actions defined by the action space data object.

In some embodiments, the process 600 includes, at step/operation 606, generating a composite loss metric. For example, the computing system 100 may generate, using a composite loss function, the composite loss metric for the first machine learning model. The composite loss metric may be based on (i) a first loss metric based on a comparison between the prediction output and a plurality of historical reward measures and (ii) a second loss metric based on a comparison between the prediction output and an imitation output corresponding to the prediction output. In some examples, the plurality of historical reward measures may be based on the one or more outcomes of the training tuples.

In some examples, the composite loss metric is further based on a hyper-parameter indicative of a deviation allowance from one or more observed actions. The one or more observed actions, for example, may be manually defined by a domain policy.

In some embodiments, the first loss metric includes an expected outcome loss that is generated based on the prediction output, an importance weight for the training entity, and/or a discounted reward for the training entity that is based on an aggregation of the plurality of reward measures.

In some embodiments, the second loss metric includes an imitation loss, and the imitation output is generated by a second machine learning model that is previously trained using an imitation loss function. The imitation loss function may be based on a comparison between a training output and an observed action identified by a domain policy.

In some embodiments, the process 600 includes, at step/operation 608, modifying a machine learning model. For example, the computing system 100 may modify one or more model parameters of the first machine learning model based on the composite loss metric.

Accordingly, as described above, various embodiments of the present disclosure make important technical contributions to improving predictive accuracy of causal transformer models by training the models to account for potential rewards while grounding predictions with trusted actions defined by domain policies. In this way, causal transformer models may be trained to generate reliable predictions that may improve upon domain standards without circumventing standards that are acknowledged by used in the user within the prediction domain. By doing so, a machine learning model may be trained to generate predictions that are trusted while suggesting unconventional, reward-based actions that may ultimately improve a prediction domain.

Some techniques of the present disclosure enable the generation of action outputs that may be performed to initiate one or more prediction-based actions to achieve real-world effects. The training techniques of the present disclosure may be used, applied, and/or otherwise leveraged to enhance machine learning models, which may help in the computer predictions in various prediction domains. The enhanced machine learning models of the present disclosure may be leveraged to initiate the performance of various computing tasks that improve the performance of a computing system (e.g., a computer itself, etc.) with respect to various prediction-based actions performed by the computing system 100, such as intelligent action recommendations, action modeling, and/or the like. Example prediction-based actions may include the generation of action recommendations tailored to a particular entity (e.g., patient, etc.) and/or one or more prediction-based actions derived from the action recommendation, such as the identification of a condition (e.g., medical condition, and/or the like) for which a prediction-based action may be initiated to automatically address.

In some examples, the computing tasks may include prediction-based actions that may be based on a prediction domain. A prediction domain may include any environment in which computing systems may be applied to achieve real-word insights, such as action recommendations and initiate the performance of computing tasks, such as prediction-based actions to act on the real-world insights (e.g., derived from action recommendations, etc.). These prediction-based actions may cause real-world changes, for example, by controlling a hardware component, providing alerts, interactive actions, and/or the like.

Examples of prediction domains may include financial systems, clinical systems, autonomous systems, robotic systems, and/or the like. Prediction-based actions in such domains may include the initiation of automated instructions across and between devices, automated notifications, automated scheduling operations, automated precautionary actions, automated security actions, automated data processing actions, and/or the like.

In some embodiments, the interpretation techniques of the process 600 are applied to initiate the performance of one or more prediction-based actions. A prediction-based action may depend on the prediction domain. In some examples, the computing system 100 may leverage the training techniques to initiate the action recommendation, initiate a treatment based on an action recommendation, and/or the like.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising receiving, by one or more processors, a plurality of training tuples for a training entity; generating, by the one or more processors and using a first machine learning model, a prediction output for the training entity; generating, by the one or more processors and using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and modifying, by the one or more processors, one or more model parameters of the first machine learning model based on the composite loss metric.

Example 2. The computer-implemented method of example 1, wherein the composite loss metric is further based on a hyper-parameter indicative of a deviation allowance from one or more observed actions.

Example 3. The computer-implemented method of example 2, wherein the one or more observed actions are manually defined by a domain policy.

Example 4. The computer-implemented method of any of the preceding examples, wherein the second loss metric comprises an imitation loss and the imitation output is generated by a second machine learning model that is previously trained using an imitation loss function.

Example 5. The computer-implemented method of example 4, wherein the imitation loss function is based on a comparison between a training output and an observed action identified by a domain policy.

Example 6. The computer-implemented method of any of the preceding examples, wherein (i) the plurality of training tuples corresponds to a training temporal sequence for the training entity, (ii) the training temporal sequence defines an evaluation time period with a plurality of time segments, and (iii) a training tuple of the plurality of training tuples comprises a state token, an action token, and an outcome token for the training entity at a time segment of the plurality of time segments.

Example 7. The computer-implemented method of example 6, wherein the state token is indicative of a state for the training entity, the action token is indicative of one or more action combinations for the training entity, and the outcome token is indicative of one or more outcomes for the training entity.

Example 8. The computer-implemented method of example 7, wherein the one or more action combinations correspond to one or more of a plurality of actions defined by an action space data object and the prediction output comprises a probability score for an action of the plurality of actions.

Example 9. The computer-implemented method of examples 7 or 8, wherein the plurality of reward measures is based on the one or more outcomes.

Example 10. The computer-implemented method of any of the preceding examples, wherein the first loss metric comprises an expected outcome loss that is generated based on the prediction output, an importance weight for the training entity, and a discounted reward for the training entity that is based on an aggregation of the plurality of reward measures.

Example 11. The computer-implemented method of any of the preceding examples, wherein the plurality of training tuples is previously generated by generating one or more action tokens, each representing a unique combination of actions from an available action space; filtering the one or more action tokens according to exclusion criteria; and imputing one or more excluded tokens by replacing one or more filtered action tokens with one or more similar non-excluded action tokens.

Example 12. A computing system comprising memory and one or more processors communicatively coupled to the memory, the one or more processors configured to receive a plurality of training tuples for a training entity; generate, using a first machine learning model, a prediction output for the training entity; generate, using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and modify one or more model parameters of the first machine learning model based on the composite loss metric.

Example 13. The computing system of example 12, wherein the composite loss metric is further based on a hyper-parameter indicative of a deviation allowance from one or more observed actions.

Example 14. The computing system of example 13, wherein the one or more observed actions are manually defined by a domain policy.

Example 15. The computing system of any of examples 12 through 14, wherein the second loss metric comprises an imitation loss and the imitation output is generated by a second machine learning model that is previously trained using an imitation loss function.

Example 16. The computing system of example 15, wherein the imitation loss function is based on a comparison between a training output and an observed action identified by a domain policy.

Example 17. The computing system of any of examples 12 through 16, wherein (i) the plurality of training tuples corresponds to a training temporal sequence for the training entity, (ii) the training temporal sequence defines an evaluation time period with a plurality of time segments, and (iii) a training tuple of the plurality of training tuples comprises a state token, an action token, and an outcome token for the training entity at a time segment of the plurality of time segments.

Example 18. The computing system of example 17, wherein the state token is indicative of a state for the training entity, the action token is indicative of one or more action combinations for the training entity, and the outcome token is indicative of one or more outcomes for the training entity.

Example 19. The computing system of example 18, wherein the one or more action combinations correspond to one or more of a plurality of actions defined by an action space data object and the prediction output comprises a probability score for an action of the plurality of actions.

Example 20. One or more non-transitory computer-readable storage media including instructions that, when executed by one or more processors, cause the one or more processors to receive a plurality of training tuples for a training entity; generate, using a first machine learning model, a prediction output for the training entity; generate, using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and modify one or more model parameters of the first machine learning model based on the composite loss metric.

1. A computer-implemented method, the computer-implemented method comprising:
receiving, by one or more processors, a plurality of training tuples for a training entity;
generating, by the one or more processors and using a first machine learning model, a prediction output for the training entity;
generating, by the one or more processors and using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and
modifying, by the one or more processors, one or more model parameters of the first machine learning model based on the composite loss metric.

2. The computer-implemented method of claim 1, wherein the composite loss metric is further based on a hyper-parameter indicative of a deviation allowance from one or more observed actions.

3. The computer-implemented method of claim 2, wherein the one or more observed actions are manually defined by a domain policy.

4. The computer-implemented method of claim 1, wherein the second loss metric comprises an imitation loss and the imitation output is generated by a second machine learning model that is previously trained using an imitation loss function.

5. The computer-implemented method of claim 4, wherein the imitation loss function is based on a comparison between a training output and an observed action identified by a domain policy.

6. The computer-implemented method of claim 1, wherein:
(i) the plurality of training tuples corresponds to a training temporal sequence for the training entity,
(ii) the training temporal sequence defines an evaluation time period with a plurality of time segments, and
(iii) a training tuple of the plurality of training tuples comprises a state token, an action token, and an outcome token for the training entity at a time segment of the plurality of time segments.

7. The computer-implemented method of claim 6, wherein the state token is indicative of a state for the training entity, the action token is indicative of one or more action combinations for the training entity, and the outcome token is indicative of one or more outcomes for the training entity.

8. The computer-implemented method of claim 7, wherein the one or more action combinations correspond to one or more of a plurality of actions defined by an action space data object and the prediction output comprises a probability score for an action of the plurality of actions.

9. The computer-implemented method of claim 7, wherein the plurality of reward measures is based on the one or more outcomes.

10. The computer-implemented method of claim 1, wherein the first loss metric comprises an expected outcome loss that is generated based on the prediction output, an importance weight for the training entity, and a discounted reward for the training entity that is based on an aggregation of the plurality of reward measures.

11. The computer-implemented method of claim 1, wherein the plurality of training tuples is previously generated by:
generating one or more action tokens, each representing a unique combination of actions from an available action space;
filtering the one or more action tokens according to exclusion criteria; and
imputing one or more excluded tokens by replacing one or more filtered action tokens with one or more similar non-excluded action tokens.

12. A computing system comprising memory and one or more processors communicatively coupled to the memory, the one or more processors configured to:
receive a plurality of training tuples for a training entity;
generate, using a first machine learning model, a prediction output for the training entity;
generate, using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and
modify one or more model parameters of the first machine learning model based on the composite loss metric.

13. The computing system of claim 12, wherein the composite loss metric is further based on a hyper-parameter indicative of a deviation allowance from one or more observed actions.

14. The computing system of claim 13, wherein the one or more observed actions are manually defined by a domain policy.

15. The computing system of claim 12, wherein the second loss metric comprises an imitation loss and the imitation output is generated by a second machine learning model that is previously trained using an imitation loss function.

16. The computing system of claim 15, wherein the imitation loss function is based on a comparison between a training output and an observed action identified by a domain policy.

17. The computing system of claim 12, wherein:
(i) the plurality of training tuples corresponds to a training temporal sequence for the training entity,
(ii) the training temporal sequence defines an evaluation time period with a plurality of time segments, and
(iii) a training tuple of the plurality of training tuples comprises a state token, an action token, and an outcome token for the training entity at a time segment of the plurality of time segments.

18. The computing system of claim 17, wherein the state token is indicative of a state for the training entity, the action token is indicative of one or more action combinations for the training entity, and the outcome token is indicative of one or more outcomes for the training entity.

19. The computing system of claim 18, wherein the one or more action combinations correspond to one or more of a plurality of actions defined by an action space data object and the prediction output comprises a probability score for an action of the plurality of actions.

20. One or more non-transitory computer-readable storage media including instructions that, when executed by one or more processors, cause the one or more processors to:
receive a plurality of training tuples for a training entity;
generate, using a first machine learning model, a prediction output for the training entity;
generate, using a composite loss function, a composite loss metric for the first machine learning model that is based on (i) a first loss metric based on a comparison between the prediction output and a plurality of reward measures and (ii) a second loss metric based on a comparison between the prediction output and an imitation output corresponding to the prediction output; and
modify one or more model parameters of the first machine learning model based on the composite loss metric.
